(19) United States
(12) Patent Application Publication
(10) Pub. No.: US 2004/0075763 A1
(43) Pub. Date: Apr. 22, 2004

(54) Conversion of interwoven video to raster video

(76) Inventor: Keith I. Tognoni, Duluth, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/273,572

(22) Filed: Oct. 17, 2002

(51) Int. Cl. H04N 7/01

(52) U.S. Cl. 348/441

(57) ABSTRACT

A method and apparatus for converting interwoven digital video signal to raster video signal utilizing a plurality of buffers with the functions of reading the interwoven video signal and sending the raster video signals. The method writes the interwoven video data in a substantially interspacing manner, and then reads the raster video signal out in a substantially contiguous manner. This method preferably writes to a first buffer while reading a second buffer and then alternates the function of the buffers by reading from the first buffer and writing from the second buffer.

### TECHNICAL FIELD

The present invention relates generally to the conversion of video formats, and more specifically to the conversion of interwoven video formats to standard raster video formats.

### BACKGROUND OF THE INVENTION

Technological advances have resulted in various types of video displays, such as cathode ray tubes (“CRTs”) and liquid crystal displays. A video source such as a camera or thermal imaging sensor may transmit signals for illustration on a video display. These signals may represent lines, circles, letters, numbers, as well as other characters. Commonly these display devices utilize “rasters” to display or recording a video image line by line. For example, computer monitors and televisions use this method where electrons are beamed (scanned) onto the phosphor coating on the screen a line at a time from left to right starting at the top-left corner. At the end of the line, the beam is turned off and moved back to the left and down one line, which is known as the horizontal retrace (flyback). When the bottom-right corner is reached, a vertical retrace (flyback) returns the gun to the top-left corner. In a TV signal, this is known as the vertical blanking interval.

Commonly there are 25 or 30 frames per second depending on the standard used. For example, the NTSC standard is 25 frames per second and the PAL standard is 30 frames per second. Each relate to the standard electrical transmission frequency used in the countries that developed the standards.

To produce a color image on a CRT, three separate electron beams are used, each directed at one of three different colored phosphors. The three phosphor colors are Red, Green and Blue and may be arranged on the CRT face in a variety of ways such as a triad of (R)ed, (G)reen & (B)lue (RGB) dots or stripes.

Raster monitors are designed to display the video signal received from a raster scan tracing signal. Unfortunately, not all video signals are “standard,” as discussed above, or even in a raster format. For example, some devices utilize interwoven video patterns. An interwoven video pattern is one that does not follow a standard raster video pattern. Such video formats arise from the peculiarities of certain cameras, CCDs or thermal devices. A non-standard interwoven video pattern typically draws every other pixel on a line during one sweep and then “fills in” the missing pixels on the next sweep. A non-standard video signal typically provides pixel data for non-sequential, or “every other” picture element for a row or a column of a display device in a first pass. Then the interwoven video pattern will then “fill in” the “skipped” picture elements (pixels) in a subsequent pass. For example, a non-standard video signal may first provide, from low to high, data information for all of the odd pixels of a display row, then provide, from high to low, data information for all of the even pixels for the same display row. Alternatively the interwoven video signal may provide all of the odd pixel information from low to high for each of the rows of the display and then provide all of the even pixel information from low to high for all of the rows. This same process could be done for the vertical columns rather than the horizontal rows of the display.

When a non-standard pattern is used, a display device must be designed to receive the non-standard display and display it in an appropriate format. One skilled in the art will appreciate that the design of non-standard display devices is typically costly. There are four reasons for this. First, for images of identical pixel count and vertical frame refresh the horizontal line, the frequency will be four times as high as an interlaced raster format and twice as high as a progressive raster format. Second, in order to keep the “alternate” pixels in their correct locations the horizontal positional accuracy must also be consistent from field to field. Third, the interwoven pattern may be in the form of a reversed relationship between the vertical rate and the horizontal rate. And finally, the interwoven pattern may be in the forms where half the pixels being drawn from left to right and half from right to left.

For the foregoing reasons, an interwoven pattern cannot be display directly on a Flat-Panel Device (“FPD”), as an FPD typically incorporates interface electronics that are designed for raster scan video sources.

Therefore, until now, to incorporate an FPD in an imaging device, which utilizes a non-standard interwoven pattern, it has been necessary to redesign the FPD to include new interface electronics, which are designed for the corresponding non-standard interwoven video pattern of the imaging device. One skilled in the art will appreciate that the new interface electronics would include a specialized timing circuitry as well as addition circuitry design and implementation. Most “off-the-shelf” devices do not have electronic circuitry for non-standard interwoven video patterns. In particular FPDs rarely, if ever, contain such circuitry. Additionally, there is a growing popularity for use of liquid crystal displays (“LCDs”). In particular there is a demand for incorporating LCDs into imaging devices. This is likely due to the fact that LCDs generally use less space and last longer than CRTs, as well as the fact they use a digital input for operation.

Therefore, there is a need for a method and apparatus to provide an interface between a non-standard interwoven video imaging device and a standard display device.

### SUMMARY OF THE INVENTION

The present invention meets the needs as described above as it provides a method and apparatus for converting interwoven video formats to standard raster video formats. Interwoven video essentially provides data for “every other” pixel on a display line, while raster video essentially provides data for contiguous pixels. To translate interwoven video to raster video, the present invention recognizes the pattern of the interwoven video and then through the recognized pattern “places” the data into assigned memory locations to provide efficient and quick retrieval of the raster video signal by retrieving essentially contiguous locations.

Generally described, the method of converting interwoven digital video signal to a raster video signal begins with the step of receiving an interwoven digital video signal. The interwoven digital video signal typically has a plurality of data elements and an interwoven pattern associated with the signal. The system then interspacingly, or non-contiguously, writes the data elements to memory locations of a first memory buffer based on the interwoven pattern of the video stream. Following this writing of the data elements, the method sequentially reads the memory locations of the first memory buffer into a raster video signal. The reading process may be initiated by receiving a full frame from the interwoven digital video signal.

This process may be repeated with a second memory buffer by writing to the buffer in an interspacing, or non-contiguous, manner. Then the process reads from the second buffer in a continuous manner. The reading from the first memory buffer is preferably performed while the method writes to the second memory buffer. Additionally, the writing and reading steps may be synchronized based on a control signals contained in the interwoven video signal. This method may be implemented through a computer storage medium comprising computer-executable instructions for performing the present invention. Alternatively, an apparatus may be configured to perform the present invention.

In an alternative embodiment of the invention, the method converts the interwoven digital video signal to the raster video signal through steps comprising storing a first portion of the interwoven digital video signal in memory in a substantially non-continuous manner to leave undisturbed interstitial memory spaces. Then the method stores a second portion of the interwoven digital video signal in memory in the undisturbed interstitial memory spaces in a manner to effectively arrange the interwoven digital video signal in memory in a sequence to allow it to be outputted in a substantially sequential, raster arrangement.

This alternative embodiment may read the first memory out as raster video, and while reading the first memory, perform the steps of storing a first portion of a second frame of the interwoven digital video signal in a second memory in a substantially non-continuous manner to leave undisturbed interstitial memory spaces. Then the method stores a second portion of the first frame of the interwoven digital video signal in the second memory in the undisturbed interstitial memory spaces in a manner to effectively arrange the interwoven digital video signal in memory in a sequence to allow it to be outputted in a substantially sequential, raster arrangement. Following this, the second memory may be read out as raster video.

The process may be repeated as necessary, switching between reading from and writing to a buffer, while alternating the writing to and the reading from another buffer.

### BRIEF DESCRIPTION OF THE DRAWINGS

FIG. 1a is a depiction of a Progressive Standard Raster Scan Video Pattern that may be outputted as converted video in the present invention.

FIG. 1b is a depiction of an Interlaced Standard Raster Video Pattern that may be outputted as converted video in the present invention.

FIG. 2a is a first example of a Non-Standard Interwoven Video Pattern that may be converted from in the present invention.

FIG. 2b is a second example of a Non-Standard Interwoven Video Pattern that may be converted from in the present invention.

FIG. 2c is a third example of a Non-Standard Interwoven Video Pattern that may be converted from in the present invention.

FIG. 3a is a depiction of writing in the interwoven video pattern of FIG. 2a into memory in an embodiment of the present invention.

FIG. 3b is a first depiction of reading out the raster video in an embodiment of the present invention.

FIG. 3c is a second depiction of reading out the raster video in a 90% scaled in comparison to the interwoven video in an embodiment of the present invention.

FIG. 3d is a third depiction of reading out the raster video in a 70% scaled in comparison to the interwoven video in an embodiment of the present invention.

FIG. 4a is a schematic block diagram of a first embodiment of the present invention.

FIG. 4b is a schematic block diagram of an alternative embodiment of the present invention.

FIG. 5 is a depiction of an embodiment of a method of practicing the present invention.

FIG. 6 is a depiction of the subroutine of receiving the interwoven video source signal, as shown in FIG. 5.

FIG. 7 is a depiction of the subroutine of receiving the interwoven video input data, as shown in FIG. 5.

FIG. 8 is a depiction of the subroutine of receiving the interwoven video control signals, as shown in FIG. 5.

FIG. 9 is a depiction of the subroutine of creating the control buffer selection signals, as shown in FIG. 5.

FIG. 10 is a depiction of the subroutine of switching the functionality of the buffers, as shown in FIG. 9.

FIG. 11 is a depiction of the subroutine of calculating the output memory controls and addresses, as shown in FIG. 5.

FIG. 12 is a depiction of the subroutine of utilizing a fixed clock, as shown in FIG. 11.

FIG. 13 is a depiction of the subroutine of utilizing a PLL clock oscillator, as shown in FIG. 11.

FIG. 14 is a depiction of the subroutine of outputting the raster video display data, as shown in FIG. 5.

FIG. 15 is a depiction of the subroutine of sending the interwoven video data to the selected buffer, as shown in FIG. 5.

### DETAILED DESCRIPTIONS OF EXEMPLARY EMBODIMENTS

In describing the embodiments of the present invention, specific terminology is employed for the sake of clarity. The invention, however, is not intended to be limited to the specific terminology so selected. The present invention converts nonstandard interwoven video into raster video. The raster video provided thereby may be either interlaced or progressive scanned. Additionally, the refresh rate need not be the same for the input interwoven display signal and the output raster video. This is because the input and output need not be frame locked when a separate fixed clock oscillator, in conjunction with a dual buffer configuration of the present invention, is utilized.

The interwoven video format typically provides “every other” pixel, or data element, of the interwoven video stream. These data elements are for pixels that are interspaced, or non-contiguous, from one another, for a vertical row or horizontal column on a display. For example, the interwoven video format may provide every “odd” pixel for every row, then provide every “even” pixel for every row.

In comparison, a raster video stream provides sequential or contiguous display locations on a vertical row. While raster video may have interspaced rows, as seen in an interlaced video stream, it does not have interspaced pixels in the row, and instead provides the pixels sequentially.

The present invention accounts for this by writing the interwoven stream in memory locations that are interspaced, or non-contiguous. For example, when receiving the example interwoven video stream discussed above, for the “odd” pixel portion of the stream, is written to corresponding odd memory addresses of the row and then for the “even” pixel portion of the stream, is written to corresponding even memory addresses of the row. It should be understood that these interspaced, or noncontiguous, memory addresses may have some contiguous addresses. For example, when the interwoven video pattern first provides the odd addresses for a horizontal row, from first pixel address to the highest odd, or “n”th -1, pixel address, and then provides the even addresses for the line, from the highest even pixel address, or “n”th pixel, to lowest even pixel, or the second pixel, there will be some contiguous addresses (specifically the (“n”th-1) pixel and the “n”th pixel in the present example). However, the terminology as used herein “non-contiguous” and interspacingly account for this possibility and include this meaning in the present application. Additionally, non-contiguous and interspacingly may repeat a pixel address or “skip” a pixel address when the interwoven video is scaled in size by the system. For example, if the system scales the interwoven video certain pixel may be skipped, repeated, or averaged with another. However, it is preferable to scale upon reading out the raster video, because the neighboring pixel values are available for standard practice algorithms.

The raster video is then read from these memory addresses in a sequential, or contiguous, manner for each row. This process will allow for progressive or interlaced raster video as the rows selected to read will account for which type of video is desired. Additionally, the raster video need not be of the same display dimensions as the reading of the data, as it may be modified to read in a manner of skipping, repeating or averaging some of the pixels. These alternative reading methods are included in the present invention when discussing sequential or contiguous reading of the elements. As with the terms interspacingly and non-contiguous, terms of sequential and contiguous may include repeated or “skipped” address when accounting for scaling of the video size. The terms when used herein, account for those possibilities within their meanings.

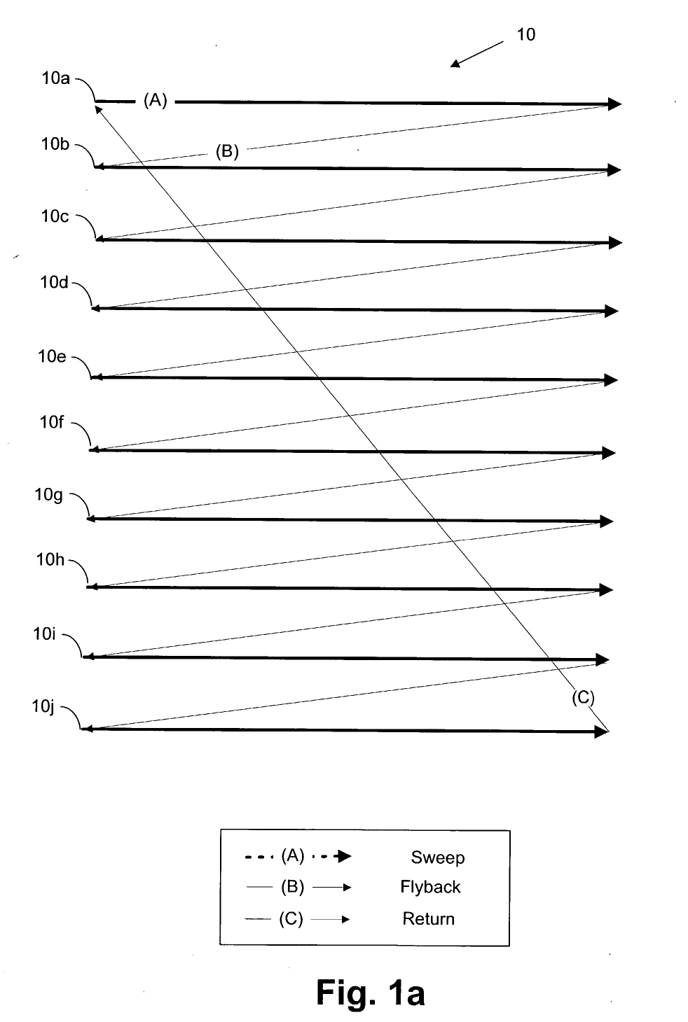

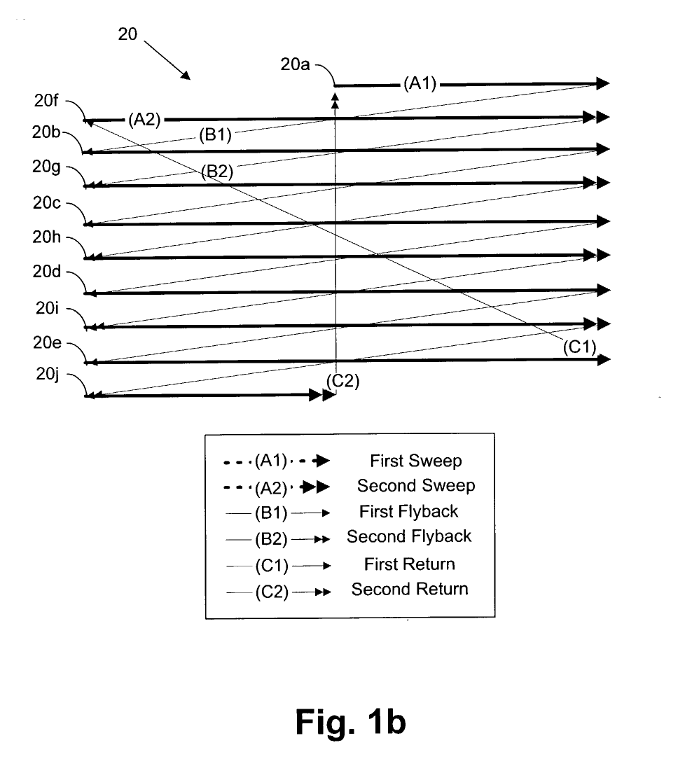

Interwoven video signals are significantly different from raster video signals. Raster video signals may be progressive or interlaced. As depicted in FIG. 1a, an example of a progressive standard raster scan video pattern 10 for a frame has a single field with lines 10a-10j, which starts at the top-left of the screen and while going to the bottom-right, the electron beam is turned, and left on, a line at a time (A), then turned off to go back to the next line (B), then off once again to go back up to the top (C).

An example of an interlaced standard raster video pattern 20 is depicted in FIG. 1b. This interlaced standard raster video pattern 20 has two fields in each frame. This interlaced pattern 20 provides the first field by first scanning the top field, which comprises the odd scan rows 20a-20e (i.e. 1,3,5,7,9,11, . . . etc.) followed by the interlaced pattern 20 providing the second field, which comprises the even scan rows 20f-20j (i.e. 2,4,6,8,10,12, . . . etc.).

It is important to note, that for a single row, the “pen” is “on” for the entire row. The “pen” connotes the apparatus that “lights” the display pixels. Therefore, the raster video stream will contain information for sequential, or contiguous, elements or pixels of the display.

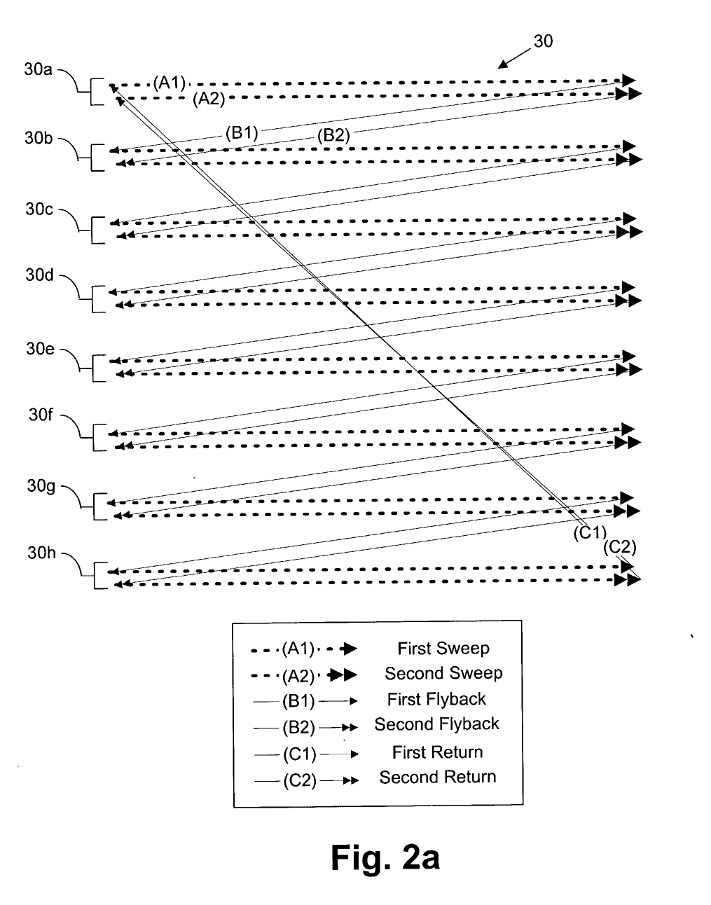

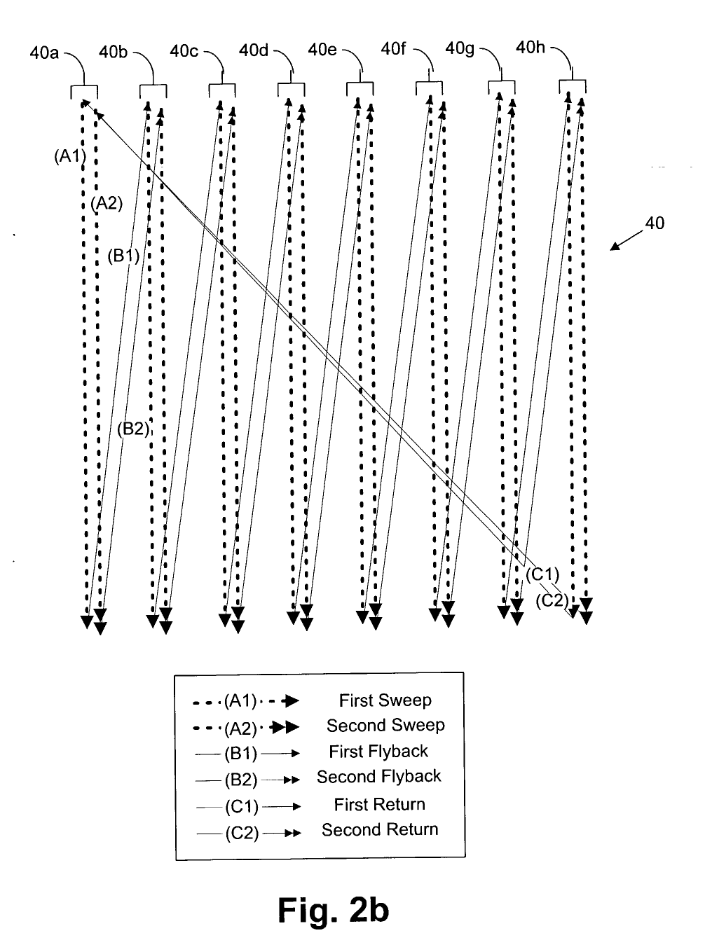

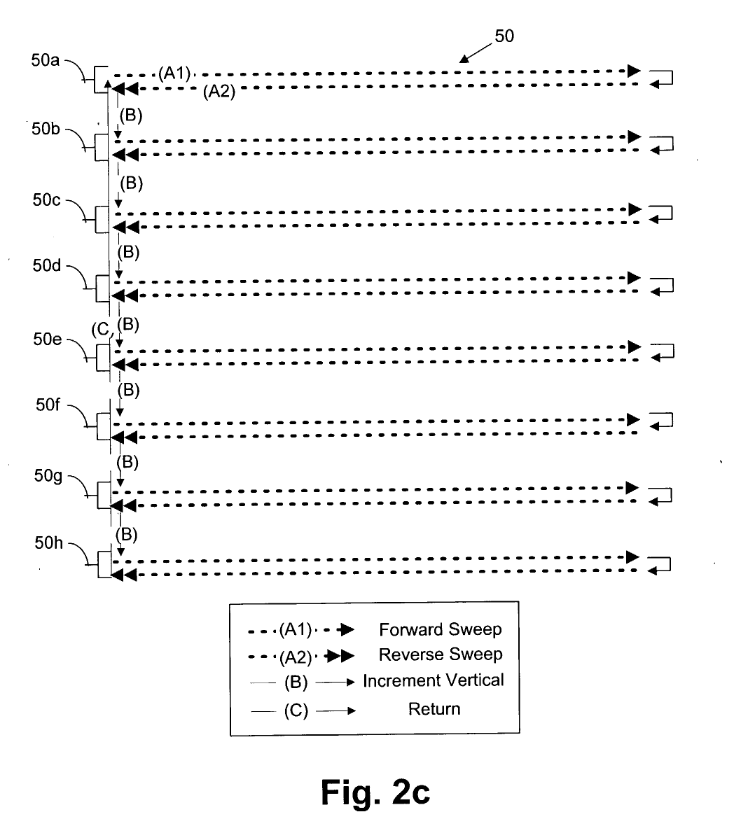

Conversely, interwoven video signals provide information about “every other” element in a row, or a column, of the display. As depicted in FIGS. 2a-c, the first “sweep,” or field, provides data values for the “odd” pixels of the rows, which is the first pixel through the (“n”th-1) pixel. This is assuming a numbering scheme for the pixel layout of the first pixel to the (“n”th-1) pixel where “n”is an even value. The second “sweep,” or field, provides the even pixel data values for the rows, which is the second pixel to the “n”th pixel. The reader should note that the “dashes” in FIGS. 2a-c represent the respective “on and off” of the pen. To illustrate these different times of the first and second sweeps, the (A1) and the (A2) sweeps are “separated” in FIGS. 2a-c from one another for purposes of clarity only. However, it should be understood that these sweeps are on the same display row, and the second sweep “fills in” the “off” portion of the first sweep with its own “on” portion, and is “off” where the first sweep was “on” in the row.

As shown in FIG. 2a, a first interwoven signal embodiment 30 first provides the data of the odd locations from the first pixel data value to the (“n”th-1) pixel data value, for a first horizontal row 30a. Then the signal provides the data for a second horizontal row 30b, again providing the data values of the odd pixels. This process then repeats from the first row 30a to the last row 30h. Following sending the last odd address, the (“n”th-1) pixel, of the last row 30h, the video provides data of the even address from the second pixel to the “n”th pixel of the first row 30a. Following sending the last even address of the first row 30a, the signal 30 provides the first even address for the second row 30b and continues by sending the even addresses starting at the second pixel, until sending the last even address, the “n”th pixel of the last row 30h. Following this, a new frame is sent by the interwoven signal 30, beginning with the first pixel of the first row once again.

As shown in FIG. 2b, a second interwoven signal embodiment 40 first provides the data of the odd locations from the first pixel data value to the (“n”th-1) pixel data value, for a first vertical column 40a. Then the signal provides the data for a second vertical column 40b, by again providing the data values of the odd pixels. This process then repeats itself by providing data for the second column 40a to the last column 40h. Following providing the last odd address, the (“n”th-1) pixel, of the last column 40h, the video provides data of the even address from the second pixel to the “n”th pixel of the first column 40a. Following providing the last even address of the first column 40a, the interwoven signal 40 provides the first even address for the second column 40b and continues by providing the even addresses starting at the second pixel, until providing the last even address, the “n”th pixel of the last column 40h. Following this, a new frame is provided by the interwoven signal, beginning with the first pixel of the first column once again.

As shown in FIG. 2c, a first interwoven signal embodiment 50 first provides the data values of the odd locations from the first pixel data value to the (“n”th-1) pixel data value, for a first horizontal row 50a. The signal 50 then provides the highest, or the “n”th, even address for the first row 50a and continues providing the even addresses in a decreasing manner starting at the “n”th pixel, until providing the lowest even address, which is second pixel of the row 50a. The signal 50 then provides the odd data values, low to high, and then the even data values from high to low, for each of the rows 50b-50h until reaching the second pixel, of the last row 50h. The signal then returns to the first odd pixel value of row 50a.

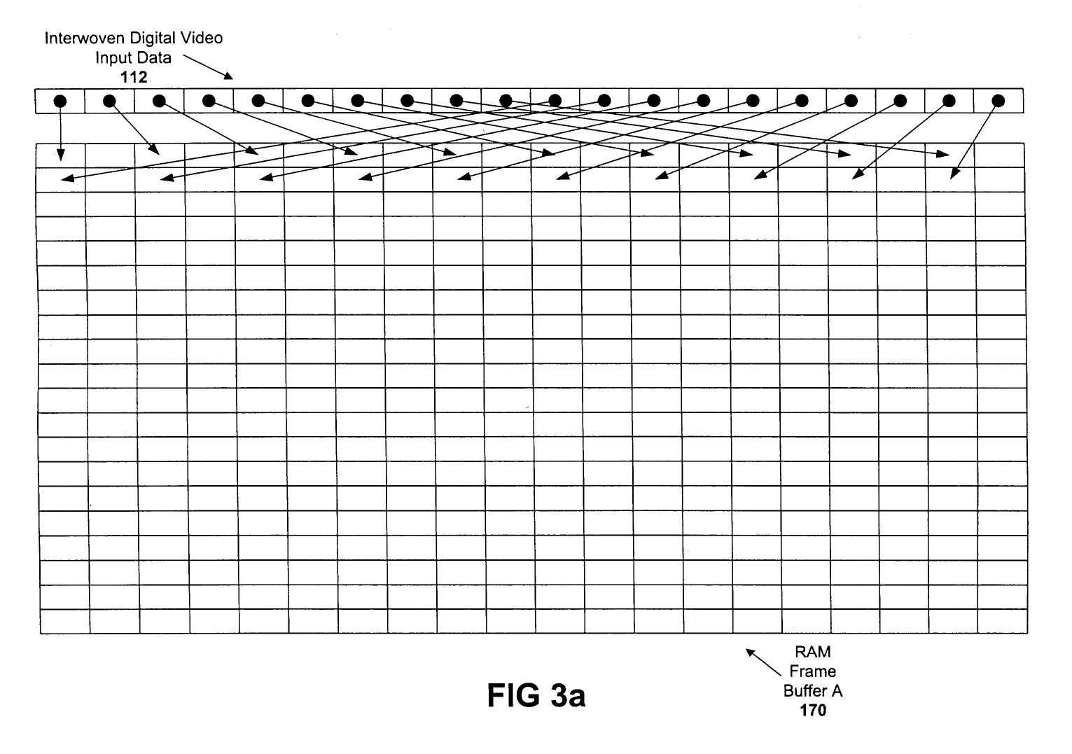

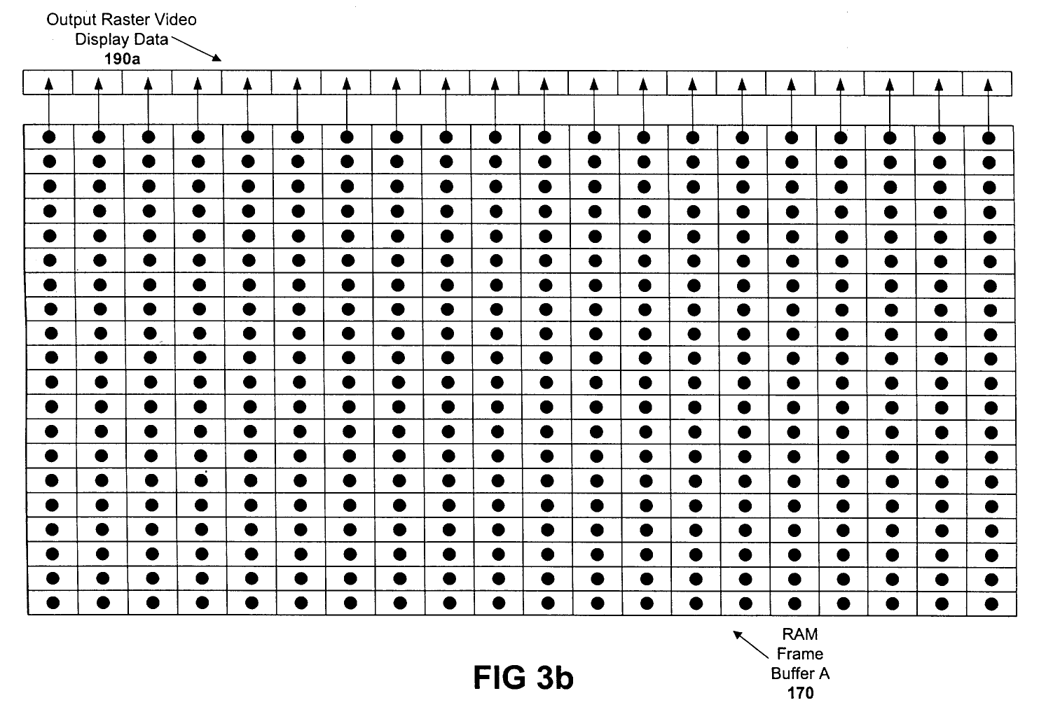

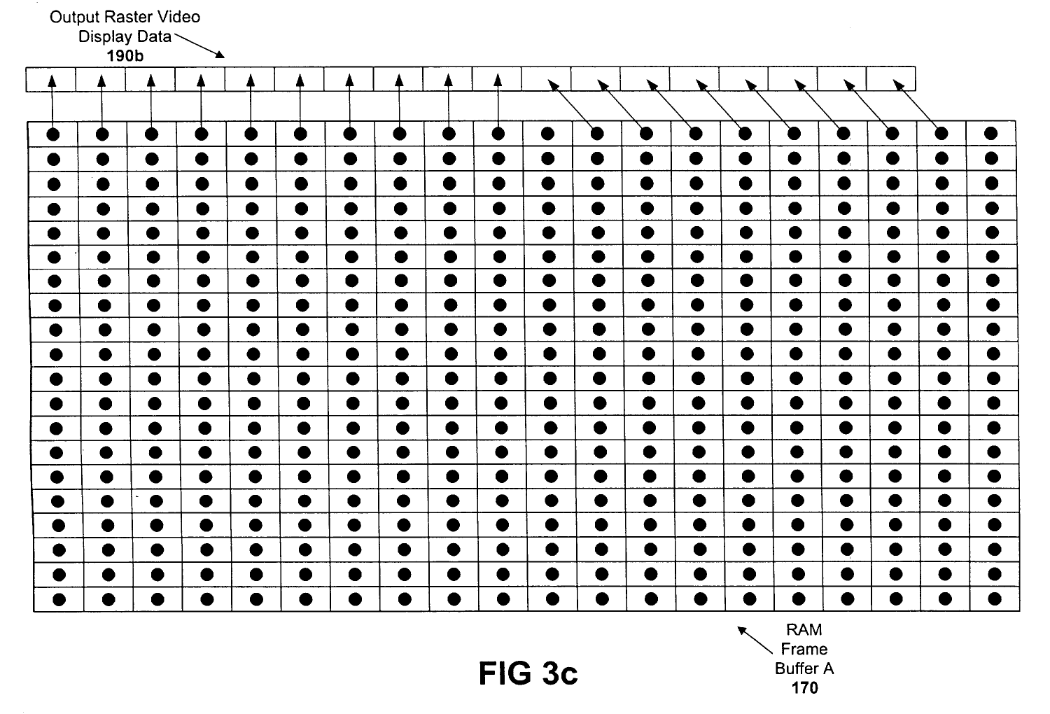

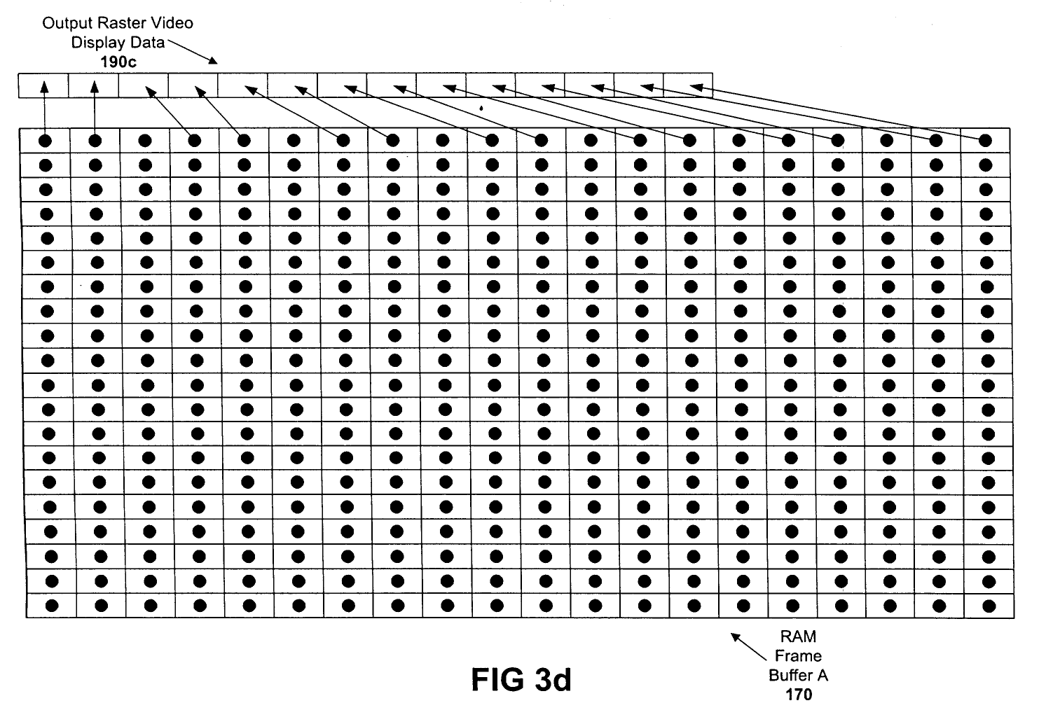

FIG. 3a provides a depiction of writing an interwoven digital video input data signal 112, which has a pattern similar as depicted in FIG. 2a, into a RAM frame buffer A 170, wherein the arrows indicate which of the memory address each of the displayed pixel are written. FIG. 3b depicts an example of writing out the RAM frame Buffer A 170 to a output raster video display data 190a. As shown in FIG. 3b, there is no scaling of the raster video, indicating that the raster and interwoven signals are of the same “size.” However, FIGS. 3c-3d depict various scaling down of the raster video 190b in size, in comparison to the interwoven video 112. In this method certain values are “skipped” to provide the decrease in scale. Forms of averaging the values of memory locations, representing the pixels, may be utilized in scaling down the size. One skilled in the art will appreciate that scaling “up” when the dimensions of the raster video 190b is larger than the size of the interwoven video 112, repeating or averaging of memory locations may be utilized.

The present invention preferably utilizes buffers, which are used for at least two functions. These functions include the function of writing the input signal from an interwoven video signal to the buffer and the function of reading the data from the buffer to a raster video display. Additionally, these functions may be swapped or switched with one another. This switch is preferably on the completion of a frame of the interwoven video signal. This means two fields have been completed when receiving video signals as discussed previously in conjunction with FIGS. 2a-2c.

To accomplish this, the method entails receiving the interwoven digital video signal from an interwoven video source. This interwoven digital video signal typically contains both data signals and control signals.

The data signals are written to alternating buffers to specified memory locations based on the control signals, as well as the “pattern” of the interwoven video signal. As discussed in the background, the “pattern” of interwoven video signals may vary. Therefore the pattern will affect the address locations the buffer for where the data is written. These addresses may be calculated, utilizing the interwoven control signals and the interwoven video pattern, preferably by an input address generator. The input address generator preferably increments the address based on the input signal's pattern, so that when a complete frame is received, the data is stored sequentially, element by element or pixel by pixel, to assist in displaying on, or reading out to, a raster video display. The input address generator may recognize the completion of a frame based on the interwoven video control signals.

A buffer control device may be coupled with the input address generator. The buffer control device preferably determines when a first buffer has received a full frame. When a full frame is received, the buffer selection device “switches” from writing the interwoven video data to the first buffer, to writing the interwoven video data to a second buffer. At the same time, reading the raster video data is switched from reading the data from the second buffer, to reading the data from the first. Additionally, the buffer selection device may provide the signal to the raster display device to “switch” reading from one buffer to the other. This “switching” may be done in conjunction with a memory arbitrator device. One should appreciate that more than two buffers may be utilized if desired.

In parallel to the input address generator and the buffer selection device, is an output address generator. The output address generator may calculate the output addresses for the raster display device as well as the output raster control signals. The output control signals may be utilized to provide the timing, blanking, and syncing information necessary for raster video format and aspects to be utilized. The output addresses will assign the locations for the pixels or display elements. A raster clock may provide the timing for the address. This raster clock may be a simple oscillating clock, thereby allowing for the interwoven and raster display timings to be independent of one another. Alternatively, the raster clock and output address control calculations may be tied into the interwoven control signals, thereby allowing for frame locking between the interwoven and raster display signals.

One skilled in the art will appreciate that the interwoven video display and the raster video display may be of different refresh rates and of different aspect sizes. Therefore it is necessary for the raster display to utilize the appropriate pixel or display element in the correct location on the raster display screen. This is done by assigning an associated output RAM address to the pixel by the output address generator.

A memory arbitrator may assist in alternating the functions of the buffers based on the control switch. Due to, in part, the input and output address calculations, when a buffer than has received the interwoven data to the assigned addresses, and the following the buffer function “switch” is subsequently is read in association with the output addresses, the video signal is effectively converted from the interwoven signal to the raster signal.

A busswitch circuit, IC or the like is utilized to direct the output and input control and addresses to the appropriate buffers.

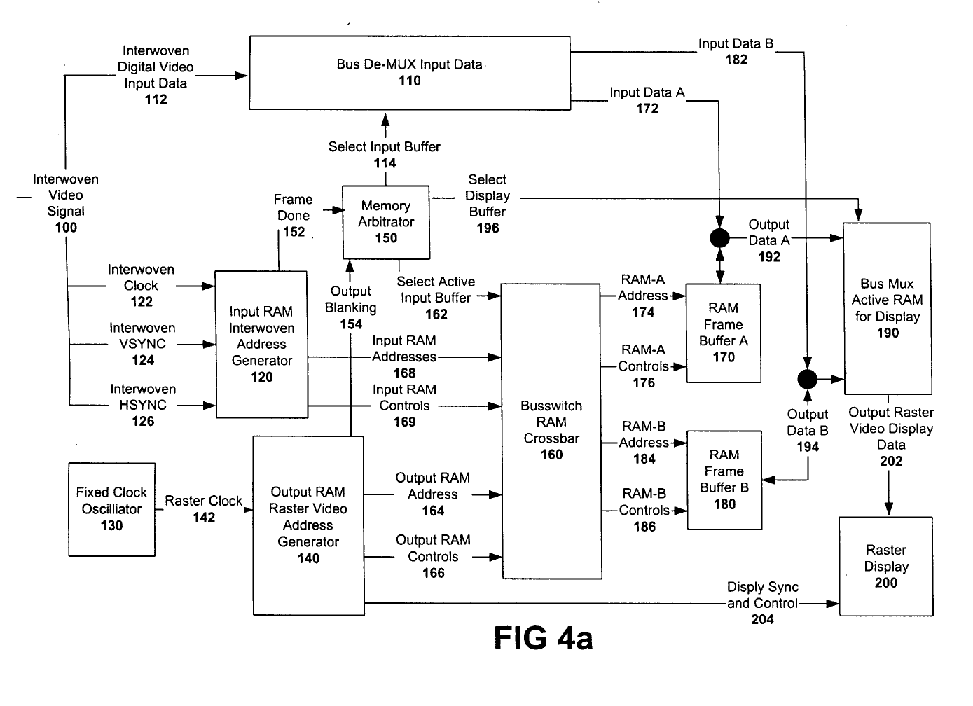

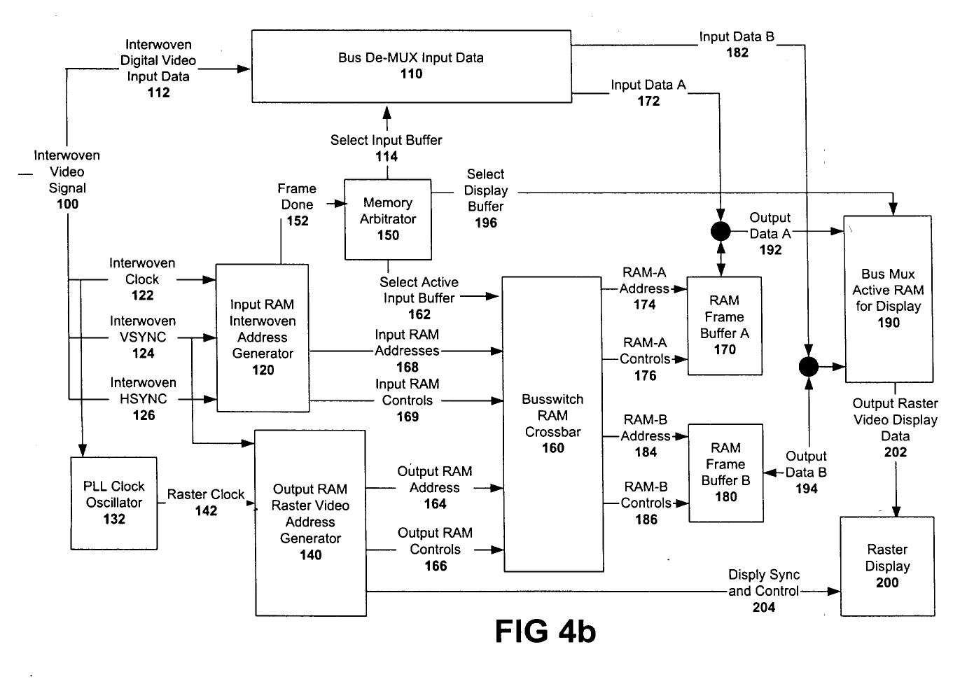

Directing the reader's attention to FIG. 4a, a schematic of a first embodiment of the present invention is depicted. An interwoven video signal 100 received from an interwoven digital video source. Examples of such sources can include cameras or thermal imagers where the sensor device is a linear array that is scanned in a non-raster fashion. The interwoven video signal 100 typically contains an interwoven digital video input data signal 112 as well as control signals, which are typically an interwoven clock 122, an interwoven VSYNC 124, and an interwoven HSYNC 126. These interwoven data signal 112 and control signals 122-126 may be separate input signals or may be combined as a single signal. In the latter case, these signals need to be decoded and separated in the present embodiment.

The control signals 122-126 are then used to convert the interwoven data signal 112 into an output raster video data 202, for display on a raster display 200.

### Bus de-MUX Input Data

A bus de-MUX input data 110 receives the interwoven digital video input data 112 from the interwoven digital video data source 100. The bus de-MUX input data 110 provides signals of Input Data A 172 and Input Data B 182. The signals are directed to RAM frame buffer A 170 and RAM frame buffer B 180, respectively. The bus de-MUX input data 110 may be implemented in programmable logic, such as a part of a Field Programmable Gate Array (“FPGA”). Alternatively, it may be implemented with a 1:2 bus de-MUX switch IC. The interwoven digital video input data 112 is directed to the active RAM frame buffer. The active buffer is either RAM frame buffer A 170 or RAM frame buffer B 180, depending on which buffer 170 or 180 is currently storing the interwoven digital video input data 112. The output of the bus de-MUX 110 to the non-active frame buffer 170 or 180 is tri-stated so that the RAM frame buffer 170 or 180 is not loaded down and data from the non-active RAM frame buffer 170 or 180 may be read out to a Display 200. An advantage of implementation of a bus de-MUX inside an FPGA is that the interwoven digital video input data 112 may be manipulated with image improvements functions such as gamma correction and the like.

### Input RAM Interwoven Address Generator

An input RAM interwoven address generator 120 receives, from the interwoven digital video signal 100, the control signals of the interwoven clock 122, the interwoven VSYNC 124 and the interwoven HSYNC 126. The interwoven VSYNC 124 and the interwoven HSYNC 126 may be positive or negative pulses during the Vblank and Hblank, respectively, associated with interwoven video input data 112. The interwoven VSYNC 124 and the interwoven HSYNC 126 associated with the interwoven video input data 112. The VSYNC 124 and the HSYNC 126 synchronizes, respectively, the vertical timing circuits and the horizontal timing circuits. Typically, the interwoven clock 122 provides one cycle per pixel. The input RAM interwoven address generator 120 may calculate when a complete frame has been received, based on the signals 122-126. Associated with receiving a complete frame, a frame done signal 152 may be sent to a memory arbitrator 150. Memory arbitrator 150 is discussed subsequently.

For example, when receiving the interwoven video signal 30, which is depicted in FIG. 2a, the horizontal counter of the input RAM address generator 120 increments by two (2) for every for every interwoven clock signal 122 during the active video time and is reset by interwoven HSYNC 126. The horizontal counter of the input RAM address generator 120 is reset to zero (0) during even fields and reset to one (1) during odd fields. The vertical counter of the input RAM address generator 120 increments by one (1) for every interwoven HSYNC signal 126 during active video time and is reset by interwoven VSYNC signal 124 following which the vertical counter is always reset to zero (0). The input RAM interwoven address generator 120 provides the decoding logic for the calculation to determine whether the current frame is odd or even. This function could be provided by a separate signal from the input video source or by encoding in the interwoven VSYNC signal 124 or the interwoven HSYNC signal 126. Additionally, some further decoding logic may be available from the input RAM interwoven address generator 120 to determine when a complete frame, encompassing two fields, has been received. As mentioned previously, when both fields have been received, thereby completing a frame, a frame done signal 152 may be sent to Memory Arbitrator 150.

### Fixed Clock Oscillator

The present embodiment utilizes a fixed clock oscillator 130, which provides a raster clock signal 142 for the output raster video address generator 140. This will be the clock signal for which the display 200 will display the interwoven digital video data 112. A standard crystal oscillator may be appropriate if it provides an appropriate signal for the desired output refresh rate for display 200.

### Output RAM Raster Video Address Generator

The output RAM raster video address generator 140 utilizes the raster clock signal 142 to provide an output blanking signal 154 to Memory Arbitrator 150. Additionally, the output RAM raster video address generator 140 provides an output RAM address signal 164 and output RAM controls 166 to a busswitch RAM crossbar 160. The busswitch RAM crossbar 160 will be discussed subsequently. The output RAM raster video address generator 140 may be implemented in programmable logic, such as a part of a FPGA. The output RAM raster video address generator 140 preferably calculates the output address 164 and output control 166 signals for ultimately reading the output display data 202 from the correct frame buffer location. Additionally, the output RAM raster video address generator 140 generates raster video timing and control signals including the previously mentioned the output blanking 154, the output RAM address 164, and the output RAM controls 166 as well as a display clock signal. The output RAM raster video address generator 140 may be two counters with enable and load functionality with one counter for the vertical aspect and the other for the horizontal aspect.

The output RAM raster video address generator 140 may also provide a display sync and control signal 204 to raster display 200. This signal provides the control signals for proper display of the raster video display data 202 on the raster display 200.

### Memory Arbitrator

The memory arbitrator 150 may be implemented in a programmable logic, such as part of an FPGA. The memory arbitrator 150, upon receiving the frame done signal 152, is notified that a complete frame has been written to RAM frame buffers A or B 170 or 180. This is the primary signal for swapping the functionality of these buffers. The memory arbitrator 150 provides a select active input buffer signal 162. When it is appropriate to swap the buffer function, select active input buffer signal 162 notifies busswitch RAM crossbar 160 to switch RAM frame buffers 170, 180. That is, if RAM frame buffer A 170 is currently writing input data A 172, then is it swapped to sending or reading output data A 192. At the same time period, RAM frame buffer B 180, which would be then sending or writing output data B 194, is then swapped to reading input data B 182. Understandably, the inverse is the other swapped possibility.

When the input interwoven digital video data 112 and the output display data 202 are not frame locked, the output RAM raster video address generator 140 may provide the output blanking signal 154. This ensures that the swamping takes place when both the input interwoven digital video data 112 and the output display data 202 are blanking. During this swap and assuming the present embodiment is translating the interwoven signal 112 as shown in FIG. 2a, the input interwoven digital video data 112 will be in vertical blanking and the output display data 202 will be in horizontal blanking.

### Busswitch RAM Crossbar

The busswitch RAM crossbar 160 may also be implemented in programmable logic, such as a FPGA or with a standard bus exchange switch IC. An example of a standard bus exchange switch IC is a Fairchild FST16209. The busswitch RAM crossbar 160 provides a RAM-A address signal 174 and a RAM-A control signal 176, as well as providing a RAM-B address signal 184 and a RAM-B control signal 186.

The signals 174,184 and the controls 176,186 may be either input video memory addresses and RAM control signals or output address and RAM control signals. If the signals 174,184 and the controls 176, 186 are being sent to the currently active buffer 170 or 180 for writing the input video data, the signals 174,184 and the controls 176, 186 consist of the interwoven digital video input data 112 (or modified version of the interwoven digital video address 168. It should be appreciated that only the memory address and RAM controls are on this path. The Data is on the separate path 110, 172, 182. If addresses 174, 184 and the controls 176, 186 are being sent to the currently active buffer 170 or 180 for reading out the data display 202, the addresses 174, 184 and the controls 176, 186 consist of the output addresses and control signals for display 200. In the latter case, and depending on which buffer 170 or 180 is active, the active RAM address frame buffer A 170 or RAM address frame buffer A 180 selects the output data A 192 or output data B 194 to a bus MUX active RAM for display 190.

### Bus MUX Active RAM for Display

The bus MUX active RAM for Display 190 may be implemented in programmable logic, such as a FPGA or with a standard 2:1 bus MUX switch IC. The output video data 192 or 194 from RAM frame buffer A 170 or RAM frame buffer A 180 provides the output raster video display data 202. It may be preferable to use the bus MUX Active RAM for Display 190 inside an FPGA. This due to the fact that an FPGA may insert the encoding data and sync information into the data stream, comprised of the output raster video display data 202, to make the data stream compatible with digital video standards. For example, the standard as discussed in ITU-R's BT.601: Studio Encoding Parameters of Digital Television for Standard 4:3 and Wide-Screen 16:9 Aspect Ratios, has synchronization information embedded in the data stream.

### PLL Clock Oscillator

An alternative embodiment is shown in FIG. 4b. In this alternative embodiment fixed clock oscillator 130 is substituted with a PLL clock oscillator 132. The PLL clock oscillator 132 would allow the present invention to frame lock the raster clock 142 to the interwoven clock 122. As shown, the interwoven clock 122 would connect to the PLL Clock Oscillator 132 as well as the Input RAM Interwoven address Generator 120. Additionally, the interwoven VSYNC 124 would connect to the Output RAM Raster Video Address Generator 140. This means that the output blanking signal 154 is no longer necessary. It is important to note that in this embodiment, the swapping of the buffers 170 and 180 will take place when both input 112 and output 202 are in their vertical blanking periods.

In another alternative embodiment the interwoven video input data 112 may be received as more than one signal. For example, the signal may be comprised of three separate signals for color video. While the buffer 170 or 180 may be utilized for reading and writing all three signals, it may be preferable to utilize separate buffers for each color. Therefore, six buffers may be used when three separate signals are received as the interwoven digital video input data 112. One skilled in the art will appreciate that while some minor modification of the Busswitch RAM crossbar 160 would be necessary, as well as a threefold increase in the number of input and output data streams 172, 182, 192, 194. The other elements of the present embodiment need to slight modification account for these changes as well. It should be appreciated that the address and control are not affected by adding color as it is just a parallel operation utilizing three buffers in place of one.

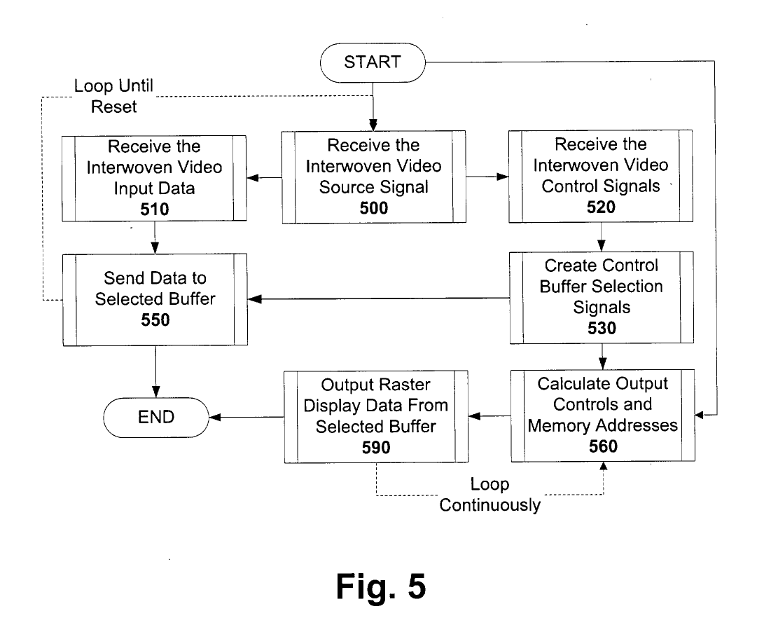

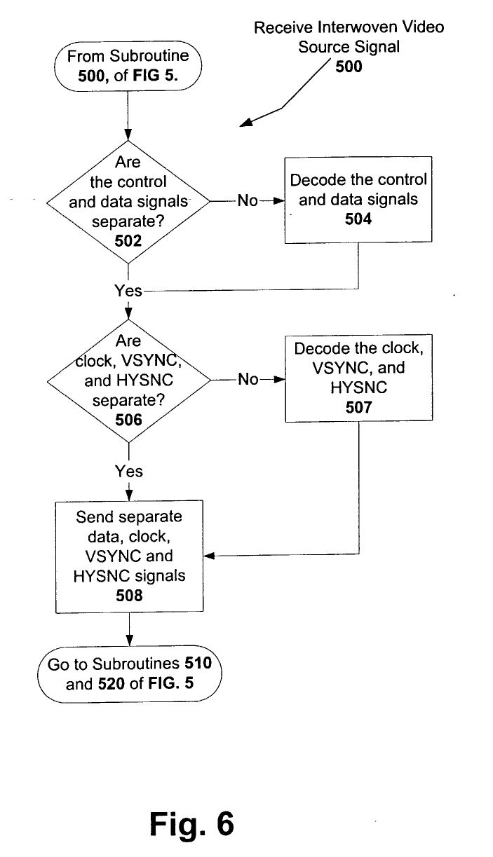

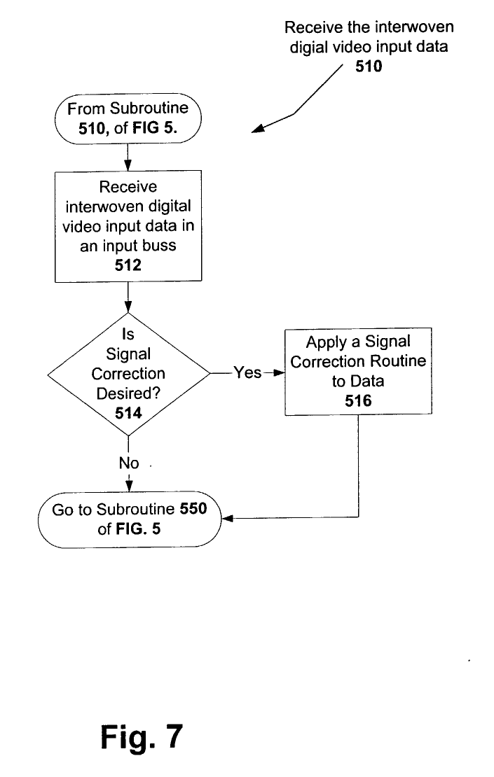

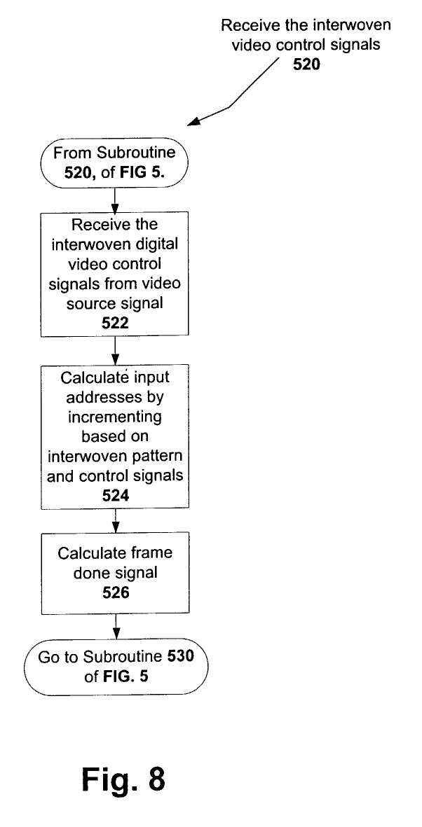

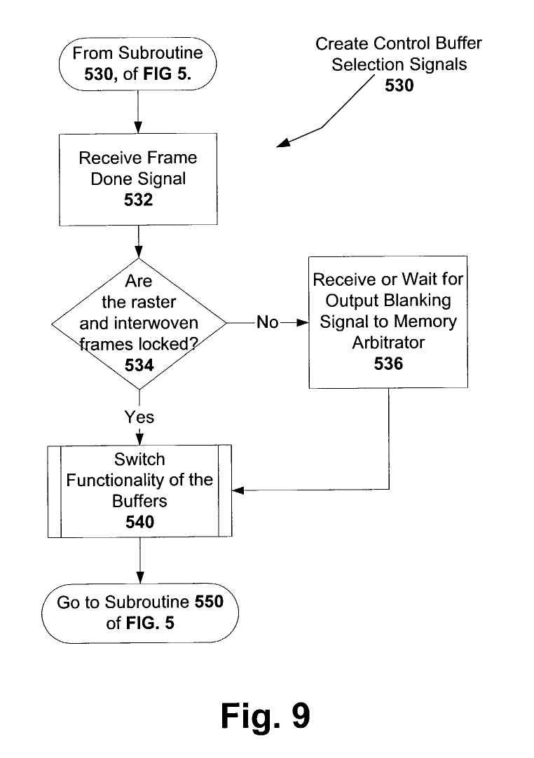

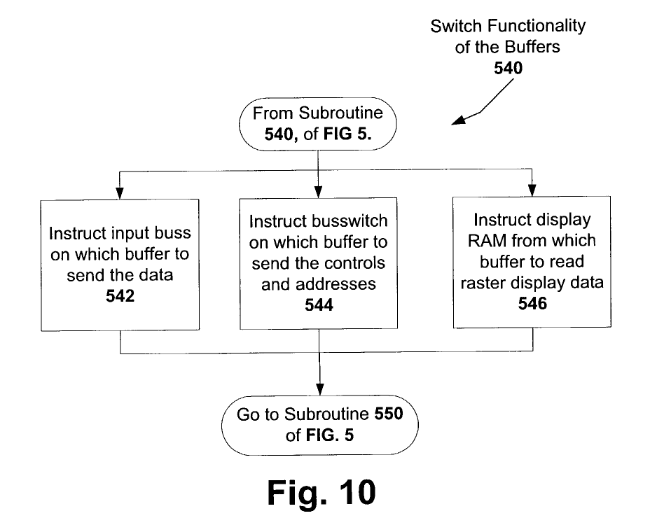

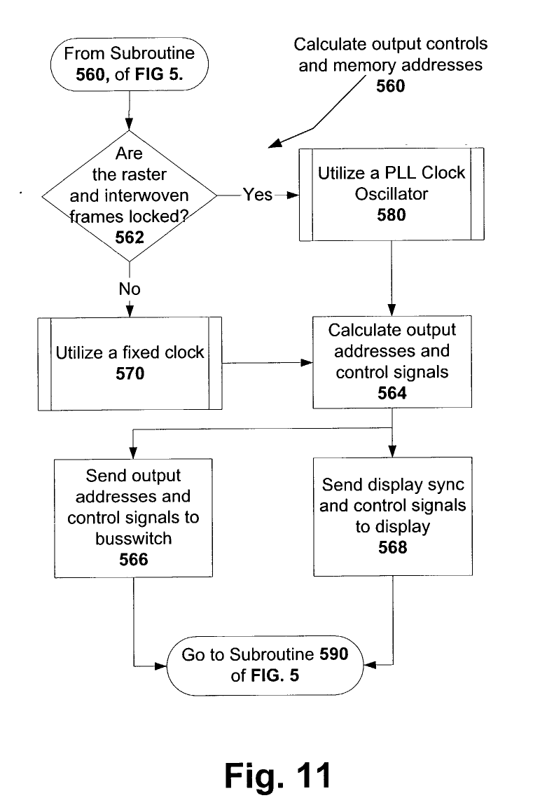

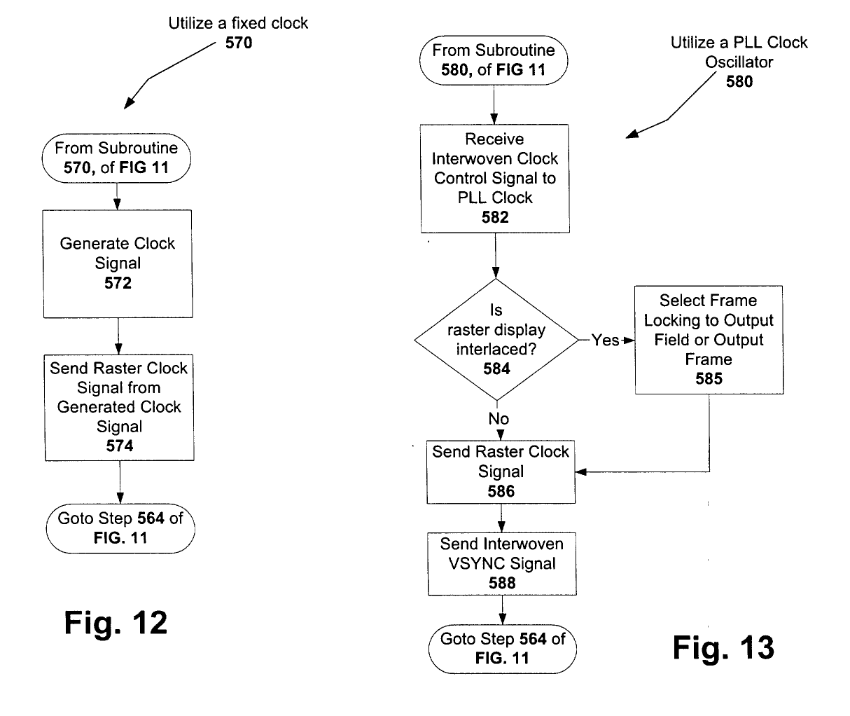

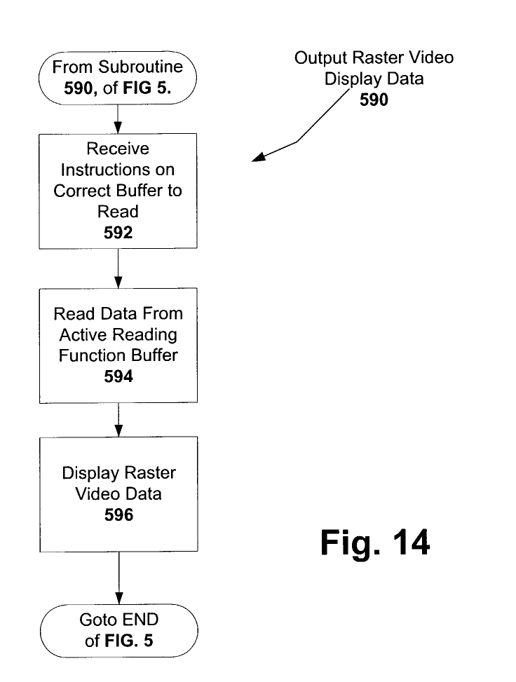

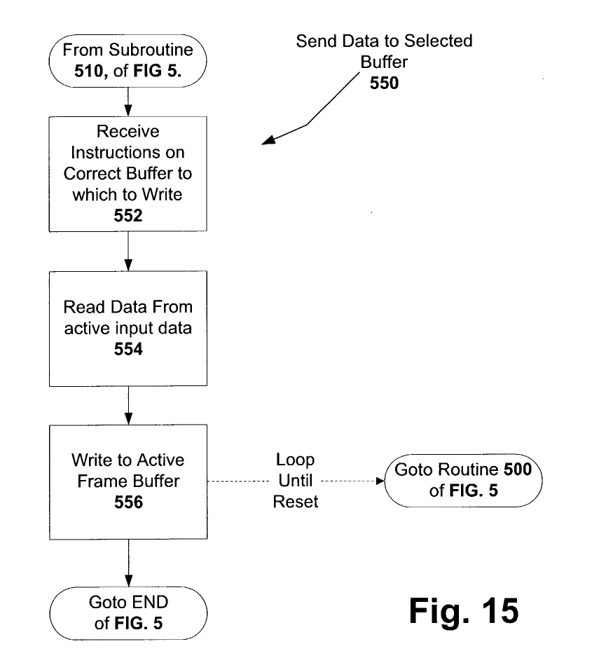

An embodiment of utilizing the present invention is depicted in FIG. 5. Following the START, the first step is subroutine 500. As shown in FIG. 6, in the first step of subroutine 500's, decision step 502 which determines if the control signals and the data signals are separate, or instead are encoded together in the video source. If the signals are separate then the “YES” branch is followed to decision step 506. However, if the signals are not separate, then the “NO” branch is followed to step 504 that then decodes the control and data signals from the interwoven video source. Following step 504 is decision step 506that determines if the interwoven clock signal, the interwoven VSYNC signal and the interwoven HSYNC signal are separate rather than being encoded. If the control signals are separate, then the “YES” branch is followed to step 508. However, if the control signals (the interwoven clock signal, the interwoven VSYNC signal and the interwoven HSYNC signal) are not separate, then the “NO” branch is followed to step 507. Step 507 decodes the interwoven clock signal, the interwoven VSYNC signal and the interwoven HSYNC signal into separate signals. Step 507 is then followed by step 508. Step 508 sends the separate data, clock, VSYNC and HSYNC signals to the appropriate components, which may include the bus de MUX input data 110 and the input RAM interwoven address generator 120. In the present method, the control and data signals are sent to separate subroutines. Step 508 is followed by subroutines 510 and 520, which are shown in FIG. 5.

Subroutine 510 receives the interwoven video data input. As shown in FIG. 7, subroutine has the first step 512 which receives the interwoven digital video input data, which may be received in an input buss, such as the bus de MUX input data 110. Following step 512 is decision step 514, which determines if it is desired to apply a signal correction routine. If is it not desirable to apply such a subroutine, then the “NO” branch is followed and step 514 is followed by subroutine 550, which is depicted in FIG. 5. However, if it is desirable to apply such a routine, then the “YES” branch is followed to step 516, which applies a signal correction routine to the data. As discussed previously this signal correction routine may be a gamma correction routine. Additional routines that may be applied will be evident to those skilled in the art. Step 516 is then followed, by subroutine 550, as shown in FIG. 5.

Subroutine 550 will be discussed subsequently. Now, turning the readers attention back to the second subroutine 520, as shown in FIG. 7, and which follows subroutine 500 (and therefore step 508) and runs in parallel to subroutine 510. Subroutine 520 has the first step 522 that receives the interwoven digital video control signals from the video source signal. Step 522 is followed by step 524, which calculates the input addresses of the interwoven video by incrementing the addresses based on the interwoven pattern and the interwoven control signals. This was discussed prior in relation to the input RAM interwoven address generator 120 in FIGS. 4-5. Step 524 is followed by step 526 that calculates when the frame is done. Preferably this calculation produces a signal or the like at the time of, or at least associated, with the frame completion time. Alternatively, the frame done signal may be taken from the clock signal and or an appropriate sync signal. For example, in the present embodiment every other VSYNC signal could be used to establish that two fields, comprising a full field as been received. Limitations of this method include establishing which of the alternating VSYNC signals corresponds to the completion of both fields (and therefore a full frame) and which VSYNC signal corresponds to the completion of just the first field. Additionally, if using this every other frame method, errors must be avoided in “missing” a VSYNC signal. One skilled in the art will appreciate the error in the signal if the frame done signal is “off” by a field. Utilizing the clock may make the method susceptible to drift errors as well. However, if these alternatives or similar alternatives are utilized, the calculation of the frame done signal may include these alternatives. Step 526 is followed by subroutine 530.

Subroutine 530, as shown in FIG. 9, has the first step of receiving the frame done signal 532. Step 532 is followed by decision step 534, which determines if the raster and the interwoven video frames are locked. If they are locked, then the “YES” branch is followed to subroutine 540. However, if the interwoven and raster video frames are not locked, the “NO” branch is followed to step 536. Step 536 waits for an output blanking signal from the output RAM raster video address generator 140, as shown in FIGS. 3-4. Step 536 is the followed by subroutine 540.

Subroutine 540, as shown in FIG. 10, may have three parallel steps. The first parallel step 542 instructs the input buss on which buffer to send the interwoven video data. The second parallel step 544 instructs the busswitch on which buffer to send the interwoven and raster controls and addresses. As discussed previously the sending of the interwoven control and address signals alternates with the sending of the raster control and address signals, are based on which buffer is receiving the interwoven data and which buffer is sending to, or being read from, the raster display 200. The third parallel step 546 instructs the raster display 200 from which buffer to read the raster display data. Following the parallel steps of 542-546, subroutine 540, and therefore subroutine 530, are followed by subroutine 550.

As discussed previously, both subroutine 510 and subroutine 530 are used by parallel routines 550 and 560. The first step of subroutine 560, as shown in FIG. 11, is the decision step 562, which determines if the raster and the interwoven video frames are locked. This is identical to decision step 534. Therefore these steps may be tied together, or at a minimum, step 534 may create a flag, that step 562 may utilize in place of making a full determination. Additionally, the designer or end user will typically make this determination. Therefore, the method, as described in the present embodiment, may be simplified based on the design.

If the frames are not locked, the “NO” branch is followed to subroutine 570, which, as shown in FIG. 11 has the first step 572. Step 572 generates a clock signal. Step 572 is followed step 574, which sends the raster clock signal 142 to the output RAM raster video address generator 140, as shown in FIG. 3, which depicts the first embodiment of the present invention. Step 574 is followed by step 564 as shown in FIG.11.

However, if the frames are locked the “Yes” branch is followed to subroutine 580, as shown in FIG. 13. This structure for this subroutine is shown in FIG. 4, which depicts the second embodiment of the present invention. Subroutine 580 starts with the step 582, which receives an interwoven clock control signal at the PLL clock oscillator 132. Step 582 is followed by decision step 584, which determines if the raster display 200 is interlaced. The designer of the conversion device, making the device in accordance to the present invention, will normally make this determination. If the raster display 200 is interlaced, then the “YES” branch is followed to step 585, which selects frame locking to the output field or to the output frame, whichever is appropriate to lock to the frame rate of the input video. Step 585 is followed by step 586. However if the raster display 200 is not interlaced, then the “NO” branch is followed to step 586, Step 586 sends the raster clock signal 142 to the output RAM raster video address generator 140. Step 586 is followed by step 588, which sends the interwoven VSYNC signal 124 to the output RAM raster video address generator 140. In this embodiment the VSYNC is utilized due to the pattern of the interwoven video, as depicted in FIG. 2a. The HSYNC may be utilized for another patterns, such as the pattern depicted in FIG. 2b. Therefore, an interwoven control signal, in conjunction with the pattern of the interwoven video pattern, assists in determining the timing of the buffer selection signal. Step 588 is followed by step 564, as shown in FIG. 11.

The parallel steps of 566 and 568 follow step 564. The first parallel step 566 sends the output addresses and control signals to the busswitch RAM crossbar 160. The second parallel step 568 sends the display sync and control signals to the raster display 200. The parallel steps of 566 and 568 are followed by the subroutine step 590, as shown in FIG. 5.

As shown in FIG. 14, subroutine's 590 first step is step 592. Step 592 receives the instructions on which is the correct buffer to read. Step 592 is followed by step 594, which reads the data from the active reading buffer. Step 594 is followed by Step 596, which display the raster video data 202 on the raster display 200. Step 596 is then followed by the END step, as shown in FIG. 5.

As shown in FIG. 15, subroutine's 550 first step is step 552. Step 552 receives instructions on which is the correct buffer to which to write. Step 552 is followed by step 554, which reads the data from the active input data. Step 594 is followed by Step 556, which writes the raster video data 202 to the active frame buffer. Step 556 is then followed by the END step, as shown in FIG. 5. Alternatively Step 556 may be followed by routine 500 when in a loop. This loop should be done until a reset is received.

In view of the foregoing, it will be appreciated that the method and apparatus for conversion of interwoven video format into standard raster video format according to the present invention, avoids the drawbacks of prior systems. The specific techniques and structures employed by the invention to improve over the drawbacks of the prior systems and accomplish the advantages described herein will become apparent from the following detailed description of the embodiments of the invention and the appended drawings and claims.

1. A method of converting interwoven digital video signal to a raster video signal comprising the steps of:
receiving an interwoven digital video signal, wherein the interwoven digital video signal comprises a plurality data elements, and wherein the interwoven digital video signal has a pattern;
interspacingly writing the data elements to a plurality memory locations of a first memory buffer based on the interwoven pattern; and
sequentially reading the memory locations of the first memory buffer into a raster video signal.

2. The method of claim 1 wherein the step of sequentially reading the memory locations is performed following receiving a frame of the interwoven digital video signal.

3. The method of claim 2 further comprising the steps of:
interspacingly writing the data elements to a plurality of memory location of a second memory buffer based on the interwoven pattern; and
sequentially reading the memory locations of the second memory buffer into a raster video signal.

4. The method of claim 3 wherein the step of reading from the first buffer is executed while the step of writing to the second buffer is executed.

5 The method of claim 3 further comprising the step of:
synchronizing the writing the data elements and the reading the data elements on a control signal contained in the interwoven video signal.

6 The method of claim 3 wherein the step of reading from the second buffer is executed while the step of writing to the first buffer is executed.

7. The method of claim 1 further comprising the step of:
synchronizing the writing the data elements and the reading the data elements on a control signal contained in the interwoven video signal.

8. A computer storage medium comprising computer-executable instructions for performing the method of claim 1.

9. An apparatus configured to perform the method of claim 3.

10. A method of converting an interwoven digital video signal to a raster video signal comprising the steps of:
storing a first portion of the interwoven digital video signal in memory in a substantially non-continuous manner to leave undisturbed interstitial memory spaces; and
storing a second portion of the interwoven digital video signal in memory in the undisturbed interstitial memory spaces in a manner to effectively arrange the interwoven digital video signal in memory in a sequence to allow it to be outputted in a substantially sequential, raster arrangement.

11. The method of claim 10 further comprising the steps of:
reading the first memory out as raster video;
while reading the first memory out as raster video, performing the steps of:
storing a first portion of a second frame of the interwoven digital video signal in a second memory in a substantially non-continuous manner to leave undisturbed interstitial memory spaces; and
storing a second portion of the second frame of the interwoven digital video signal in the second memory in the undisturbed interstitial memory spaces in a manner to effectively arrange the interwoven digital video signal in memory in a sequence to allow it to be outputted in a substantially sequential, raster arrangement.

12. The method of claim 11 further comprising the step of:
reading the second memory out as raster video.

13. The method of claim 12 further comprising the steps of:
while reading the second memory out as raster video, storing a first portion of a first frame of the interwoven digital video signal in a second memory in a substantially non-continuous manner to leave undisturbed interstitial memory spaces; and
storing a second portion of the first frame of the interwoven digital video signal in the second memory in the undisturbed interstitial memory spaces in a manner to effectively arrange the interwoven digital video signal in memory in a sequence to allow it to be outputted in a substantially sequential, raster arrangement.

14. The method of claim 10 wherein the first portion is a field.

15. A method of converting an interwoven digital video signal to a raster video signal comprising the steps of:
receiving a interwoven digital video signal stream;
writing the interwoven signal stream to substantially non-contiguous memory locations of a first buffer;
receiving a first full frame of data from the interwoven stream; and
in response to receiving the first full frame of data from the interwoven stream:
reading the raster video signal from substantially contiguous memory locations from the first buffer.

16. The method of claim 15 where the step of in response to receiving the first full frame of data from the interwoven stream further has the step of:
writing the interwoven signal stream to substantially non-contiguous memory locations of a second buffer.

17 The method of claim 16 where the step of in response to receiving the first full frame of data from the interwoven stream further has the step of:
receiving a second full frame of data from the interwoven stream; and
in response to receiving the second full frame of data from the interwoven stream:
writing the interwoven signal stream to substantially non-contiguous memory locations of the first buffer.
reading the raster video signal from substantially contiguous memory locations from the second buffer.

18. The method of claim 15 wherein the step of receiving a first full frame of data from the interwoven stream is determined by the receiving a control signal in the interwoven digital video signal.

19. The method of claim 15 wherein the step of writing the interwoven signal stream to substantially non-contiguous memory locations of a first buffer has the steps of:
writing the element stream to odd memory addresses of a first row of the first buffer beginning with an initial odd address of the first row, until receiving an HSYNC signal;
in response to every HSYNC signal writing to odd memory addresses of the first buffer beginning with the initial odd address of the subsequent row, until receiving a first VSYNC signal;
in response to the VSYNC signal writing the element stream to even memory addresses of the first buffer beginning with an initial even address of the first row, until receiving an HSYNC signal;
in response to every HSYNC signal writing to even memory addresses of the first buffer beginning with the initial even address of the subsequent row.

20. The method of claim 19 wherein the step in response to every HSYNC signal writing to even memory addresses, starting at one, for the subsequent row performs this step until receiving a second VSYNC signal.

21. A method of converting an interwoven digital video signal to a raster video signal comprising the steps of:
receiving an interwoven digital video signal stream;
writing the interwoven signal stream to substantially non-contiguous memory locations of a first buffer;
receiving a predetermined amount of data from the interwoven stream; and
in response to receiving the predetermined amount of data from the interwoven stream:
reading the raster video signal from substantially contiguous memory locations from the first buffer.

22. The method of claim 21 where the step of in response to receiving the predetermined amount of data from the interwoven stream further has the step of:
writing the interwoven signal stream to substantially non-contiguous memory locations of a second buffer.

23. The method of claim 22 where the step of in response to receiving the predetermined amount of data from the interwoven stream further has the step of:
receiving a second predetermined amount of data from the interwoven stream; and
in response to receiving the second predetermined amount of data from the interwoven stream:
writing the interwoven signal stream to substantially non-contiguous memory locations of the first buffer.
reading the raster video signal from substantially contiguous memory locations from the second buffer.
